(19) United States
(12) Patent Application Publication
(10) Pub. No.: US 2017/0146374 A1
(43) Pub. Date: May 25, 2017

(54) HOLOGRAPHIC STYLING

(71) Applicant: Continental Automotive Systems, Inc., Auburn Hills, MI (US)

(72) Inventors: Hiram Aburto Crespo, Tlajomulco (MX); Javier Alejandro Sola-Villalobos, Zapopan (MX); Edjar Diaz-Sanchez, Guadalajara (MX); Maria Cristina Gascon Rivera, Guadalajara (MX)

(21) Appl. No.: 14/951,672

(22) Filed: Nov. 25, 2015

(51) Int. Cl. G01D 13/28

(52) U.S. Cl. CPC G01D 13/28

(57) ABSTRACT

An instrument panel for a motor vehicle is provided. The instrument panel includes an instrument panel surface and a plurality of indicia disposed on the instrument panel surface. The plurality of indicia comprises holographic ink.

### FIELD

The present disclosure relates to vehicle instrument panels and clusters, and more specifically to indicia on an instrument panel in a motor vehicle.

### BACKGROUND

Vehicles include instrument panels to communicate information indicative of operation to an operator. For example, motor vehicles may include instrument panels with several gauges and dials that communicate vehicle conditions such as speed, engine rpm, temperature, and oil pressure, among other operational parameters. A pointer is typically provided that rotates about a fixed axis to communicate current values of an operational parameter.

An instrument panel and gauge is a functional element of a vehicle dashboard, but also contributes to the aesthetic appearance and impression of the vehicle. Light guides and multiple LEDS are typically assembled with a housing to distribute light to the face of the instrument cluster. Each LED requires electronics associated with it.

In addition, instrument panels may include some lighting or design features that are present purely for aesthetic purposes, without conveying information about vehicle operation.

Accordingly, designers are continually seeking different configurations to improve the appearance of the instrument panel, while maintaining the required functionality, without significantly increasing the cost.

### SUMMARY

An instrument panel is provided that uses holographic ink.

In one form, which may be combined with or separate from the other forms disclosed herein, an instrument panel for a motor vehicle is provided. The instrument panel includes an instrument panel surface and a plurality of indicia disposed on the instrument panel surface. The plurality of indicia comprises holographic ink.

In another form, which may be combined with or separate from the other forms disclosed herein, an instrument cluster assembly for a motor vehicle is provided. The instrument cluster assembly includes a dial surface and a plurality of indicia printed on the dial surface. The plurality of indicia comprises holographic ink. A pointer is disposed over the dial surface. The pointer is rotatable with respect to the dial surface about a central axis. At least one light source is coupled to the pointer.

Although the different examples have the specific components shown in the illustrations, embodiments of this disclosure are not limited to those particular combinations. It is possible to use some of the components or features from one of the examples in combination with features or components from another one of the examples.

These and other features disclosed herein can be best understood from the following specification and drawings, the following of which is a brief description.

### BRIEF DESCRIPTION OF THE DRAWING

Examples are reflected in the drawing, which will be described below. The drawing described herein is for illustration purposes only and are not intended to limit the scope of the present disclosure in any way.

FIG. 1 is a schematic front view of an example vehicle dashboard and instrument panel including an instrument cluster assembly, in accordance with the principles of the present disclosure.

### DETAILED DESCRIPTION

The following description is merely exemplary in nature and is not intended to limit the present disclosure, application, or uses.

Certain terms are used throughout the following description and claims to refer to particular system components and configurations. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”.

Examples of the invention are described below. It should be noted that these and other examples or embodiments are exemplary and are intended to be illustrative of the invention rather than limiting. While the invention is widely applicable to different types of systems, it is impossible to include all of the possible embodiments and contexts of the invention in this disclosure. Upon reading this disclosure, many alternative embodiments of the present invention will be apparent to persons of ordinary skill in the art. Other embodiments may be utilized, and other changes may be made, without departing from the spirit or scope of the subject matter presented here.

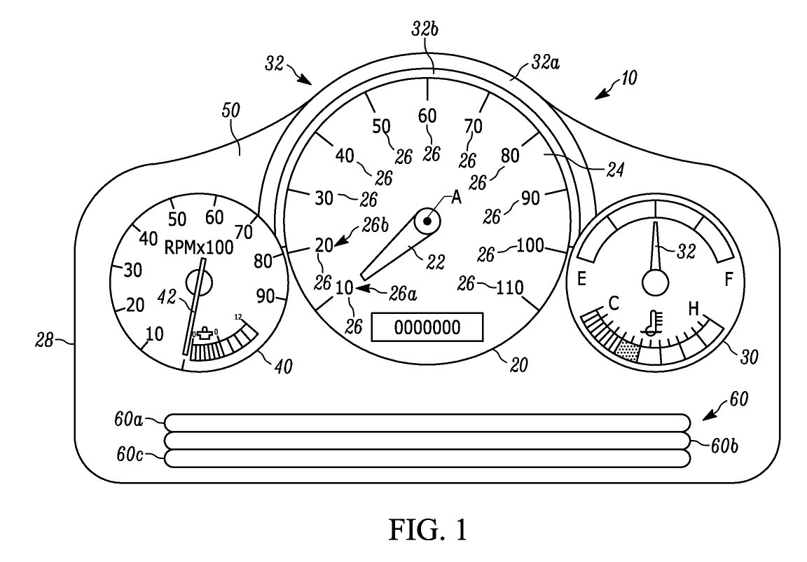

Referring to the FIG. 1, a vehicle dashboard 10 includes an instrument panel 50 including a main instrument cluster assembly 20 and several secondary gauges 30, 40. The main instrument cluster assembly 20 includes a pointer 22 that rotates about an axis A extending through a dial surface 24 to indicate a specific operating parameter. Information given by the instrument cluster assembly 20 may include, by way of example, tachometer information, vehicle speed information, fuel level information, engine temperature, or any other information that is desired to communicate to the driver of the vehicle. Several indicia 26, such as speed values, are located on the dial surface 24. The indicia 26 are disposed in a circular pattern about the axis of rotation A.

The pointer 22 is configured to rotate with respect to the dial surface 24, about the axis A. For example, the pointer 22 may be mounted to a shaft that is driven by a stepper motor (not shown). The stepper motor may be mounted to a printed circuit board (not shown). A housing 28 may surround the instrument cluster assembly 20 and/or the instrument panel 50 and/or side gauges 30, 40.

In the illustrated example, the indicia 26 comprise holographic ink. The indicia 26 may be printed onto the dial surface 24. The dial surface 24 may be opaque, transparent, or translucent. The indicia 26, thus, may appear as holograms, which are three-dimensional images of an object recreated from a pattern printed on a two-dimensional surface. In this case, the holographic indicia 26 may be printed on the dial surface 24, for example, by using ultrashort pulses of light from a common laser to create and engrave the interference pattern by heating up the ink and vaporizing it. The amount of ink removed may depend on the light intensity at each spot in the pattern. The holographic printing technique may work best when the dial surface 24 is opaque.

In some variation, the plurality of indicia 26 are created as holograms that are substantially invisible unless illuminated by light. Each indicium 26 may then become visible when it is illuminated, either by ambient light or by a light source. In this example, the pointer 22 provides a light source to illuminate the indicia 26 and make them visible. Thus, each indicium 26 is only visible when the pointer 22 is near or over the indicium 26. The pointer 22 may act as a light source by virtue of itself being a light guide to distribute light from LEDs (not shown) disposed behind the instrument panel 50, by way of example, or light sources such as LEDs may be attached to the side of the or back of the pointer 22. When the light from the pointer 22 shines on any particular indicium 26, it is illuminated and visible, in this example.

More particularly, the pointer 22 is configured to rotate about the axis A and therefore move into a variety of positions corresponding to each indicium 26. In this example, the pointer 22 can move in a continuous pattern from one indicium 26 to the next indicium 26 along the circular pattern of indicium 26. In one position, the pointer 22 may be disposed over or near the first indicium 26a to illuminate and make visible the first indicium 26a, while the rest of the indicia 26, including the second indicium 26b, remain invisible. The pointer 22 may then move into another position over or near the second indicium 26b to illuminate and make visible the second indicium 26b, while the rest of the indicia 26, including the first indicium 26a, remain invisible.

An object, such as a semi-circular ring 32, may be printed onto the instrument panel 50. The semi-circular ring 32 (or any other object) may have two parts, such as an outer ring 32a and an inner ring 32b. Each ring 32a, 32b is printed onto the instrument panel 50 with holographic ink, as described above with respect to the indicia 26, for example. The outer ring 32a may comprise a first color of holographic ink, and the inner ring 32b may comprise a second color of holographic ink. Each ring 32a, 32b may be invisible until illuminated by a light source. A control system may allow an operator to select a first mode to illuminate and make visible the outer ring 32a and a second mode to illuminate and make visible the inner ring 32b. One or more hidden light sources may be configured to shine on the outer ring 32a when the operator selects the first mode, and one or more hidden light sources may be configured to shine on the inner ring 32b when the operator selects the second mode. Thus, the operator may essentially select which color of ring 32a, 32b that he/she wants to view. Therefore, the selectively visible holographic rings 32a, 32b allow the operator to choose his/her preferred color for purposes of style.

A plurality of warning lines 60 may be printed onto the instrument panel 50 using holographic ink as described above with respect to the indicia 26 and the rings 32a, 32b. The warning lines 60 may include, for example, a first line 60a, a second line 60b, and a third line 60c. By way of example, the first line 60a may comprise a first color of holographic ink, the second line 60b may comprise a second color of holographic ink, and the third line 60c may comprise a third color of holographic ink. Each line 60a, 60b, 60c may be invisible until illuminated by a light source.

For example, a plurality of hidden light sources may be configured to selectively shine on each line 60a, 60b, 60c. A control system may selectively illuminate each line 60a, 60b, 60c based on whether or how much to warn a vehicle operator. For example, the control system may cause a light source to illuminate and make visible the first line 60a, which might be green, when no warning related to a parameter, such as tire pressure, is present; the control system may cause a light source to illuminate and make visible the second line 60b, which might be yellow, when the parameter has a mild warning (e.g., tire pressure is low, but not critically low); and the control system may cause a light source to illuminate and make visible the third line 60c, which might be red, when the parameter has a strong warning (e.g., tire pressure is critically low and the vehicle should be stopped as soon as possible).

It should be understood that any number of colored lines 60 could be used, and the warnings need not relate to tire pressure, but could be any other type of warning. The control system automatically chooses which line 60a, 60b, 60c to illuminate based on the status of the warning, in order to easily alert the driver. In another variation, the control system could illuminate no line at all when there is no warning present (e.g., tire pressure is normal) and only illuminate one of the lines 60a, 60b, 60c when a warning is programmed to be provided to the driver.

It is further understood that any of the above described concepts can be used alone or in combination with any or all of the other above described concepts. As a person skilled in the art will readily appreciate, the above description is meant as one illustration of the principles of the invention. This description is not intended to limit the scope or application of the invention in that the invention is susceptible to modification, variation, and change, without departing from the spirit and scope of the invention, as defined in the following claims.

What is claimed is:

1. An instrument panel for a motor vehicle, the instrument panel comprising:
an instrument panel surface; and
a plurality of indicia disposed on the instrument panel surface, the plurality of indicia comprising holographic ink.

2. The instrument panel of claim 1, the plurality of indicia being substantially invisible unless illuminated by light.

3. The instrument panel of claim 2, further comprising at least one light source configured to illuminate the plurality of indicia, each indicia being visible upon being illuminated.

4. The instrument panel of claim 3, wherein the instrument panel surface is opaque.

5. The instrument panel of claim 4, wherein the indicia are printed onto the instrument panel surface.

6. The instrument panel of claim 3, wherein the instrument panel surface is a dial surface of an instrument cluster gauge.

7. The instrument panel of claim 6, wherein the indicia are disposed in at least a partially circular pattern about a central axis.

8. The instrument panel of claim 7, further comprising a pointer disposed over the instrument panel surface, the dial being rotatable about the central axis and with respect to the instrument panel surface.

9. The instrument panel of claim 8, wherein the at least one light source is coupled to the pointer, the pointer being configured to move to at least a first position and a second position, the at least one light source being configured to illuminate a first indicium of the plurality of indicia when the pointer is in the first position, the at least one light source being configured to illuminate a second indicium of the plurality of indicia when the pointer is in the second position.

10. The instrument panel of claim 3, wherein a first indicium of the plurality of indicia is illuminated in a first mode and a second indicium of the plurality of indicia is illuminated in a second mode.

11. The instrument panel of claim 10, the first and second modes being selectable by an operator.

12. The instrument panel of claim 10, wherein the first indicium is visible in a first color when illuminated, the second indicium being visible in a second color when illuminated.

13. The instrument panel of claim 12, wherein a third indicium of the plurality of indicia is illuminated in a third mode, the third indicium being visible in a third color when illuminated.

14. The instrument panel of claim 13, wherein the light source is configured to automatically illuminate one of the first, second, and third indicia when a control system determines that the vehicle is operating in one of the first, second, and third modes.

15. An instrument cluster assembly for a motor vehicle, the instrument cluster assembly comprising:
a dial surface;
a plurality of indicia printed on the dial surface, the plurality of indicia comprising holographic ink;
a pointer disposed over the dial surface, the pointer being rotatable with respect to the dial surface about a central axis; and
at least one light source coupled to the pointer.

16. The instrument cluster assembly of claim 15, the light source being configured to selectively illuminate the plurality of indicia, each indicium of the plurality of indicia being substantially invisible until illuminated by the at least one light source, each indicium of the plurality of indicia being visible when illuminated by the at least one light source.

17. The instrument cluster assembly of claim 16, the dial surface being opaque.

18. The instrument cluster assembly of claim 17, the indicia being disposed in at least a partially circular pattern about the central axis, the pointer being configured to move to at least a first position and a second position, the at least one light source being configured to illuminate a first indicium of the plurality of indicia when the pointer is in the first position, the at least one light source being configured to illuminate a second indicium of the plurality of indicia when the pointer is in the second position.
